(19) United States
(12) Patent Application Publication
(10) Pub. No.: US 2005/0206092 A1
(43) Pub. Date: Sep. 22, 2005

(54) Staked retention of spiral windings for spiral wound gaskets

(75) Inventors: Robert M. Pedro JR., Fairport, NY (US); Donald Finch, Newark, NY (US)

Correspondence Address: KILPATRICK STOCKTON LLP, 1001 WEST FOURTH STREET, WINSTON-SALEM, NC, 27101, US

(73) Assignee: Garlock Sealing Technologies LLC, a Delaware corporation

(21) Appl. No.: 11/079,107

(22) Filed: Mar. 15, 2005

Related U.S. Application Data
(60) Provisional application No. 60/553,990, filed on Mar. 17, 2004.

(51) Int. Cl. F16L 17/06

(52) U.S. Cl. 277/608

(57) ABSTRACT

A spiral wound gasket comprises an annulus, centered about a central axis, comprising a plurality of superposed turns of a strip wound upon itself and a filler substantially between the turns of the strip, wherein an outer portion of the annulus extends away from the central axis; a retaining ring, centered about the central axis, annularly disposed on an outer circumference of the annulus; an inner surface of the retaining ring configured to accommodate the outer portion of the annulus, the inner surface comprising a first portion having an inclined angle; and a second portion having a counterbore, wherein at least one deformation of the retaining ring biases the counterbore thereby retaining the annulus within the retaining ring.

### CROSS-REFERENCE TO RELATED APPLICATIONS

This application claims priority to U.S. Provisional Patent Application Ser. No. 60/553,990, filed Mar. 17, 2004, which is hereby incorporated by reference in its entirety.

### FIELD OF THE INVENTION

The present invention relates to spiral wound gaskets and methods for manufacturing spiral wound gaskets. More particularly, the present invention relates to an improved method and apparatus for retaining and affixing the spiral winding within the retaining ring of a spiral wound gasket.

### BACKGROUND OF THE RELATED ART

One conventional spiral wound gasket is described in U.S. Pat. No. 5,161,807 (“the '807 patent”) entitled “Spiral Wound Gasket,” which is hereby incorporated by reference in its entirety. The '807 patent relates to a spiral wound gasket comprising an annulus constituted by a plurality of superimposed turns of a profiled metal strip wound upon itself to form a spiral and, interposed between at least some of said superimposed turns, a number of turns of a relatively soft sealant material in strip form, the thickness of said metal strip being selected so that prior to use the wound metal spiral is essentially flush with the surface of an associated guide ring and the thickness of the strip of relatively soft sealant material being selected so that prior to use, it projects a significant distance on both sides of the gasket from said superimposed metal turns axially of said annulus. The preferred relatively soft sealant material is exfoliated graphite foil, which projects from the metal spiral to define an overall gasket thickness on the order of 25 to 40 percent greater than that of the guide ring.

The basic design for spiral wound gaskets, as exemplified in the '807 patent, is illustrated in FIG. 1, marked “PRIOR ART.” FIG. 1 is a cross-sectional view of a conventional spiral wound gasket 10 rotated about an axis 60. Generally, spiral wound gasket 10 comprises an assembly of a spiral winding 20 and a retaining ring 30. Spiral winding 20 has a metal strip 40 and a filler material 50. A small amount of the metal strip 40 used in the spiral winding 20 is unsecured to the filler material 50 of the spiral winding 20. The retaining ring 30 has a “V-shaped” groove on its inner surface 80, which is achieved by a secondary machining operation. The outside diameter of the spiral winding 20 is slightly smaller than the aperture in the retaining ring 30 so that the spiral winding 20 can be positioned in the retaining ring 30.

The spiral winding 20 is inserted into the aperture of the retaining ring 30 by compressing the “tag” end of the metal strip 40 towards an axis 70, which is perpendicular to axis 60, of the spiral winding 20. The pressure exerted on the tag end pushes the V-shaped outside surface of the spiral windings 20 into the V-shaped groove on the inner surface 80 of the retaining ring 30, thereby locking the spiral winding 20 and retaining ring 30 together to form a unitized assembly.

The conventional design is sensitive to the relative diameters between the mating parts as well as the amount of metal available for a tag end. Typically, gaskets of this design are hand-modified during the assembly process. Material may be added through shimming or material may be removed by breaking off a portion of the tag end. The modifications are needed to assemble the gaskets and such that the gaskets can be fully unitized.

### SUMMARY OF THE INVENTION

Accordingly, the present invention provides a spiral wound gasket and a method of manufacturing a spiral wound gasket that is less susceptible to the relative accuracy between the dimensions of mating parts.

An object of the present invention is to provide an alternative, less costly means for retaining the spiral winding within the retaining ring of a spiral wound gasket.

Another object of the present invention is to eliminate the need for hand-modifications such as shimming or trimming the tag end, because staking provides a substantial closure of the inner periphery regardless of the relative difference in the mating diameters.

It is a further object of the present invention to eliminate the secondary operation required to produce the V shaped groove in the retaining ring significantly reducing the manufacturing cost of the ring.

In one embodiment of the invention, a spiral wound gasket comprises an annulus, centered about a central axis, comprising a plurality of superposed turns of a strip wound upon itself and a filler substantially between the turns of the strip, wherein an outer portion of the annulus extends away from the central axis; a retaining ring, centered about the central axis, annularly disposed on an outer circumference of the annulus; an inner surface of the retaining ring configured to accommodate the outer portion of the annulus, the inner surface comprising a first portion having an inclined angle; and a second portion having a counterbore, wherein at least one deformation of the retaining ring biases the counterbore thereby retaining the annulus within the retaining ring. The outer portion of the annulus extends away from the central axis in a V-shape. An axis perpendicular to the central axis extends through the center of the retaining ring and divides the inner surface of the retaining ring into the first portion and the second portion. The angle of the inclined surface is substantially similar to the angle of the strip of the annulus. The angle of the counterbore is substantially parallel to the central axis. The at least one deformation can be elongated in a radial direction. The at least one deformation can be angled substantially towards the inner surface of the retaining ring. The deformation can be caused by coining the retaining ring. An additional retainer, such as a pal nut, can be provided substantially between the retaining ring and the annulus. The at least one deformation in the retaining ring comprises approximately four to eight stakes.

In another embodiment of the invention, a method for manufacturing a gasket comprises the steps of stamping a retaining ring from a sheet of metal; stamping an inclined surface and a counterbore on an inner surface of the retaining ring; providing a spiral winding to be received by the retaining ring; and staking the retaining ring in the substantial proximity of the counterbore to retain the spiral winding within the retaining ring. Staking the retaining ring can occur at a plurality of positions. The retaining ring can also be coined. An additional retainer, such as a pal nut, can also be provided substantially between the counterbore and the spiral winding before staking.

In yet another embodiment of the invention, a method for assembling a gasket comprises the steps of providing a spiral winding having a substantially protruding outer edge; providing a retaining ring having an inner surface comprising an inclined surface and a counterbore; and biasing the counterbore towards the spiral winding. The step of biasing the counterbore can comprise coining the retaining ring. An additional retainer can be provided substantially between the counterbore and the spiral winding before staking.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description, serve to explain the principles of at least one embodiment of the invention.

In the drawings:

FIG. 1 illustrates a cross-section of a conventional spiral wound gasket comprising a retaining ring with a V-shaped groove along the inner surface and V-shaped spiral winding of metal strip/filler material secured within the groove.

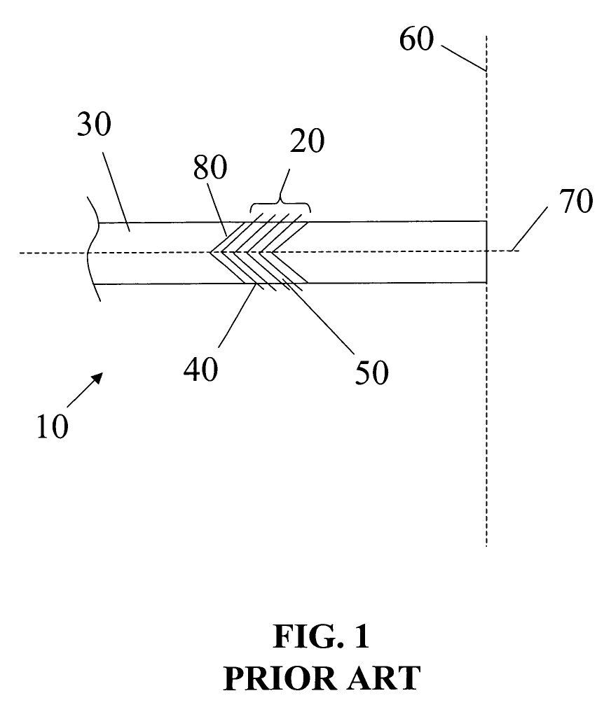

FIG. 2 illustrates a retaining ring with an inclined surface and a counterbore, in addition to spiral windings resting within the counterbore and centered therein via the inclined surface, according to an embodiment of the present invention.

FIG. 3 illustrates an embodiment of the present invention shown in FIG. 2 after the retaining ring has been staked to secure the spiral winding within the counterbore, according to an embodiment of the present invention.

FIG. 4a illustrates a frontal view of a gasket, showing the outer retaining ring, spiral winding, and stakes securing the spiral winding in place within the retaining ring, according to an embodiment of the present invention.

FIG. 4b illustrates a partial frontal view of enlarged section A of FIG. 4a, showing the outer retaining ring, inner windings and stakes securing the spiral winding in position within the retaining ring, according to an embodiment of the present invention.

FIG. 5 illustrates an elongated stake according to an embodiment of the present invention.

FIG. 6 illustrates a the retaining of a spiral winding with the use of an additional retainer, according to an embodiment of the present invention.

### DETAILED DESCRIPTION OF THE INVENTION

Reference will now be made in detail to the preferred embodiments of the present invention, examples of which are illustrated in the accompanying drawings.

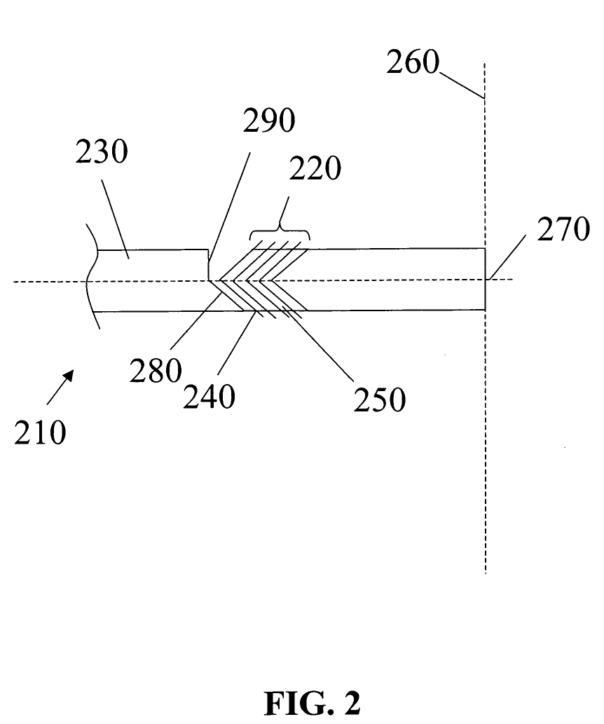

The present invention provides a spiral wound gasket having a unitized assembly of a retaining ring and a spiral winding. Referring to FIG. 2, a cross-section of spiral wound gasket 210 rotated about a central axis 260 is shown. The spiral wound gasket 210 has a spiral winding 220, which is an annulus, centered about the central axis 260, comprising a plurality of superposed turns of a strip 240 wound upon itself and a filler 250 between the turns of the strip 240. Preferably, the strips 240 are metal, such as stainless steel, and the filler 250 is graphite. The spiral winding 220 is substantially V-shaped on an outer and inner edge, wherein the tip of the V-shape extends away from the central axis 260. Similarly, the strips 240 are also V-shaped. Preferably, the strips 240 extend slightly beyond the edge of the spiral wound gasket 210. The extended portion of the strips 240 are known as the “tag” ends, which compress during use to form a seal.

The spiral wound gasket 210 also has an annular retaining ring 230 disposed on the outer edge of the spiral winding 220. The retaining ring 230 is manufactured to have an inner surface to accommodate with the spiral winding 220. However, the inner surface of the retaining ring 230 is not symmetrical about an axis 270 perpendicular to central axis 260. The inner surface of the retaining ring 230 has a first portion having an inclined feature and a second portion having a conterbore feature. Preferably, axis 270, which divides the first and second portions, extends through the center of the retaining ring 230.

The first portion includes an inclined surface 280, which has an angle substantially identical to the angle of strips 240. The inclined surface 280 serves to locate the spiral winding 220 approximately coaxial with the retaining ring 230 along the axis 270. The inclined surface 280 also serves to keep the spiral winding 220 from passing completely through the aperture in the retaining ring 230 during installation.

The second portion of the inner surface of the retaining ring 230 is positioned on the opposing side of axis 270 from the first portion. The second portion of the inner surface has a counterbore feature. The counterbore 290 has an edge that is substantially parallel to the central axis 260. The counterbore 290 serves to locate the spiral winding 220 approximately coaxial to retaining ring 230 along the central axis 260. Accordingly, the spiral wound gasket 210 has a retaining ring 230 having the spiral winding 220 disposed within the counterbore 290 and resting upon the inclined surface 280 so as to center the spiral winding 220 along axis 260 and 270 of the spiral wound gasket 210.

The geometry of the inclined angle and counterbore of the inner surface of the retaining ring can have various configurations. For the purposes of the present invention, any geometry would be suitable that brings the spiral winding and retaining ring into approximate coaxial alignment and prevents the spiral winding from passing completely through the aperture of the retaining ring.

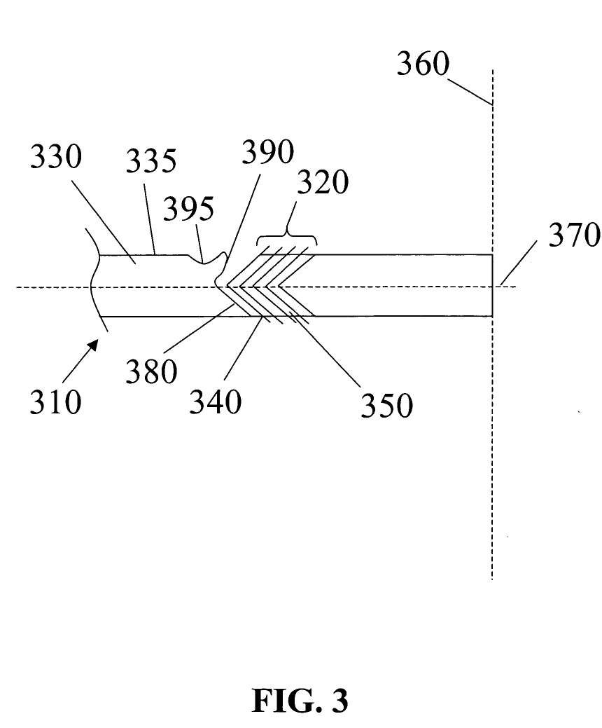

The spiral wound gasket of FIG. 2 is further processed to provide a unitized assembly. Unlike conventional designs, the unitized assembly is not formed by exerting pressure on the tag ends. Instead, the retaining ring is modified. Referring to FIG. 3, a cross-section of spiral wound gasket 310 rotatable about a central axis 360 is shown. The spiral wound gasket 310 has a spiral winding 320, which includes strips 340 and a filler 350. A retaining ring 330 is annularly disposed around the spiral winding 320. The spiral winding 320 is positioned on an inclined surface 380 of a retaining ring 330. The spiral winding 320 is approximately centered about an axis 370 as the spiral winding 320 rests on inclined surface 380. A surface 335 on retaining ring 330 is staked to deform a counterbore 390. An at least one stake 395 in the retaining ring 330 is hereinafter referred to as a “stake” or a “deformation.” The at least one stake 395 around the spiral wound gasket substantially secures the spiral winding 320 disposed within the inner surface of the retaining ring 330. By biasing the counterbore 390 against spiral winding 320, the stake 395 substantially locks the spiral winding 320 in position against the inclined surface 380 and within the inner surface of the retaining ring 330.

In the embodiments described herein, the spiral winding is secured within the retaining ring through various means, such as staking the retaining ring, coining the ring to form an annular stake, or through the use of an additional retainer such as a pal nut. One skilled in the art will recognize other means and devices for securing the spiral winding within the counterbore of the retaining ring are within the scope of the present invention.

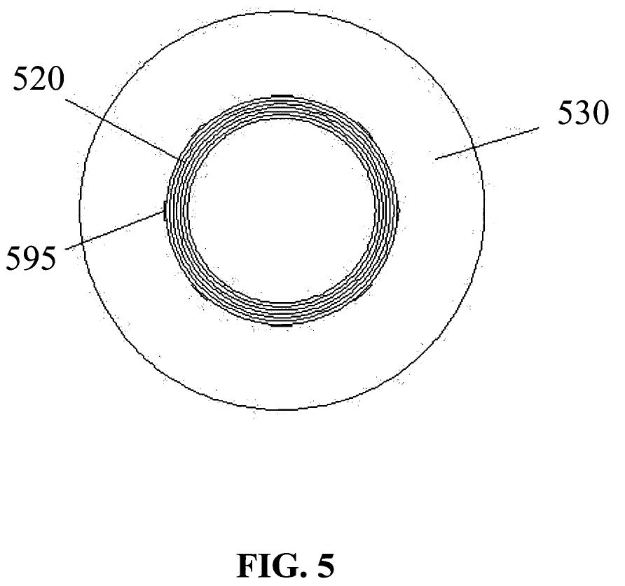

In one embodiment, the retaining ring is staked. The stakes 395 for securing the spiral winding 320 can be positioned in a plurality of configurations. One skilled in the art will recognize that the shapes or geometries of the stake are limitless as long as the staking deforms the material of the retaining ring 330 to secure the spiral winding 320 and the retaining ring 330 into a unitized assembly. In one embodiment, the stake 395 deforms the retaining ring 330 on at least one point along the surface 335 near the inner portion of the retaining ring 330. In one embodiment, the stake can be elongated in a radial direction. Referring to FIG. 5, a stake 595 in retaining ring 530 retains a spiral winding 520. In this embodiment, the length of stake 595 can be extended. In an alternative embodiment, the stake can be angled to deform a large portion of retaining ring material substantially towards the spiral windings.

In one embodiment of the present invention, a plurality of stakes are positioned along an inner portion of the surface of the retaining ring. One of ordinary skill in the art recognizes that the exact number of stakes varies depending upon the types of materials used and the size of the gasket. In a preferable embodiment, the spiral wound gasket has between four and eight stakes. More preferably, the spiral wound gasket has six stakes. In one exemplary embodiment, a spiral wound gasket having up to a twelve inch diameter has a steel retaining ring with a steel and graphite annulus. The spiral wound gasket of this exemplary embodiment has six stakes.

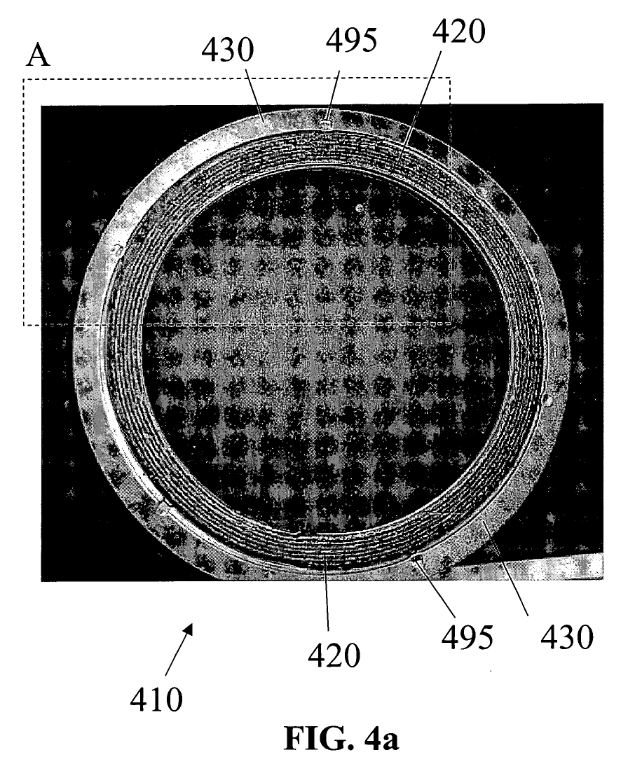

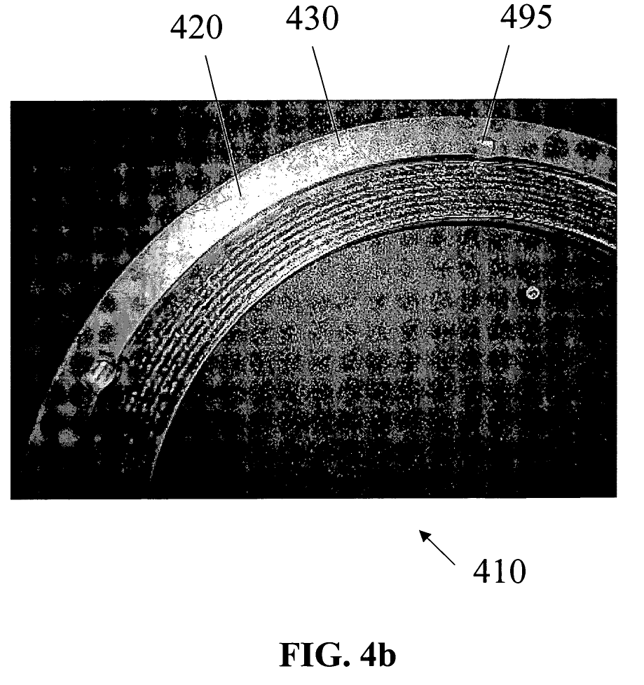

FIG. 4a illustrates a frontal view of a gasket 410 according to an embodiment of the present invention. FIG. 4b is an enlarged section A of FIG. 4a. The gasket 410 has a spiral winding 420, a retaining ring 430, and a plurality of stakes 495 securing the spiral winding 420 within the retaining ring 430. In the embodiment shown in FIGS. 4a and 4b, the retaining ring 430 has six stakes 495.

In another embodiment, the retaining ring is “coined.” “Coining” is the process of forming or stamping a substantially continuous indentation around the retaining ring. As a result of coining, a substantially continuous ring of retaining ring material extends and overlaps an outer surface of the spiral windings.

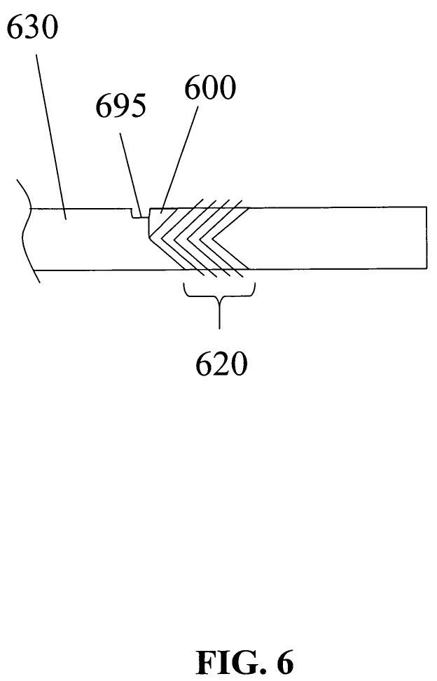

In yet another embodiment, the spiral winding is secured within the retaining ring through the use of an additional retainer. One of ordinary skill in the art recognizes that there are a variety of retainers that can be used. In one embodiment, the additional retainer is a pal nut. Referring to FIG. 6, the user of an additional retainer according to an embodiment of the invention is shown. A pal nut 600 provides retention of a spiral winding 620 around the circumference of the spiral winding 620, as opposed to only those locations retained solely by each stake 695. The pal nut 600 is a thin annular conical wedge. A top end of the conical wedge has a smaller diameter than the outer diameter of the spiral windings. A bottom end of the conical wedge has a larger diameter than both the top end diameter and the counterbore diameter of the retaining ring. The area between the top end and bottom end comprises an inner diameter that steadily decreases from the bottom end to the top end. The pal nut is inserted into the center aperture of a retaining ring 630 and pushed into position until the decreasing inner diameter of the pale nut contacts the spiral winding 620 near the top end and securely positions the spiral winding 620 within the retaining ring 630. The retaining ring 630 is staked 695 substantially proximate the pal nut 600 to secure the pal nut 600 and spiral winding 620 within the retaining ring 630.

In one embodiment of the invention, a method for assembling a spiral wound gasket is described. The method comprises the steps of stamping a retaining ring from a sheet of metal; stamping an inclined surface and a counterbore on an inner surface of the retaining ring; providing a spiral winding to be received by the retaining ring; and staking the retaining ring in the substantial proximity of the counterbore to retain the spiral winding. The step of staking the retaining ring can comprise a plurality of deformations in the retaining ring. The retaining ring can also be coined. An additional retainer, such as a pal nut, can also be provided.

In another embodiment of the invention, a method for forming a spiral wound gasket is described. A retaining ring is stamped from a sheet of material. A subsequent stamping process then forms an inclined surface and a counterbore. The subsequent stamping process eliminates the need for a conventional secondary machining operation that creates the V-shaped groove on the inner surface of the retaining ring. The stamping process is faster and, therefore, less expensive than the conventional methods. Additionally, it is easier to ensure repetitive quality when stamping. The angle and counterbore can be added to a blanking die as a progression, thereby eliminating time spent producing them. Therefore, this method provides a cost reduction in the formation of the retaining ring by eliminating the extra processing step.

The apparatus and method of the present invention offer competitive advantages in assembly cost by reducing the need to precisely fit the spiral winding and the retaining ring. The staking process ensures a secure fit of the spiral winding within the retaining ring. By staking the retaining ring, the spiral winding and retaining ring can also have larger tolerances in their dimensions.

Although the present invention has been described with reference to particular embodiments, it should be recognized that these embodiments are merely illustrative of the principles of the present invention. Those of ordinary skill in the art will appreciate that the spiral wound gaskets and methods of manufacturing a spiral wound gasket of the present invention may be constructed and implemented in other ways and embodiments. Accordingly, the description herein should not be read as limiting the present invention, as other embodiments also fall within the scope of the present invention.

While the invention has been described in detail and with reference to specific embodiments thereof, it will be apparent to those skilled in the art that various changes and modifications can be made therein without departing from the spirit and scope thereof. Thus, it is intended that the present invention cover the modifications and variations of this invention provided they come within the scope of the appended claims and their equivalents.

1. A gasket comprising:
an annulus, centered about a central axis, comprising a plurality of superposed turns of a strip wound upon itself and a filler substantially between the turns of the strip, wherein an outer portion of the annulus extends away from the central axis;
a retaining ring, centered about the central axis, annularly disposed on an outer circumference of the annulus;
an inner surface of the retaining ring configured to accommodate the outer portion of the annulus, the inner surface comprising:
a first portion having an inclined angle; and
a second portion having a counterbore, wherein at least one deformation of the retaining ring biases the counterbore thereby retaining the annulus within the retaining ring.

2. The gasket of claim 1, wherein the outer portion of the annulus extends away from the central axis in a V-shape.

3. The gasket of claim 1, wherein an axis perpendicular to the central axis extends through the center of the retaining ring and divides the inner surface of the retaining ring into the first portion and the second portion.

4. The gasket of claim 1, wherein the angle of the inclined surface is substantially similar to the angle of the strip of the annulus.

5. The gasket of claim 1, wherein the angle of the counterbore is substantially parallel to the central axis.

6. The gasket of claim 1, wherein the at least one deformation is elongated in a radial direction.

7. The gasket of claim 1, wherein the at least one deformation is angled substantially towards the inner surface of the retaining ring.

8. The gasket of claim 1, wherein the deformation is caused by coining the retaining ring.

9. The gasket of claim 1, further comprising an additional retainer inserted substantially between the retaining ring and the annulus prior to the staking of the retaining ring.

10. The gasket of claim 9, wherein the additional retainer is a pal nut.

11. The gasket of claim 1, wherein at least one deformation in the retaining ring comprises approximately four to eight stakes.

12. A method for manufacturing a gasket comprising the steps of:
stamping a retaining ring from a sheet of metal;
stamping an inclined surface and a counterbore on an inner surface of the retaining ring;
providing a spiral winding to be received by the retaining ring; and
staking the retaining ring in the substantial proximity of the counterbore to retain the spiral winding within the retaining ring.

13. The method of claim 12, further comprising the step of providing an additional retainer substantially between the counterbore and the spiral winding.

14. The method of claim 12, wherein the step of staking of the retaining ring comprises coining the retaining ring.

15. The method of claim 12, wherein the step of staking comprises deforming the retaining ring at a plurality of positions.

16. A method for assembling a gasket, the method comprising the steps of:
providing a spiral winding having a substantially protruding outer edge;
providing a retaining ring having an inner surface comprising an inclined surface and a counterbore; and
biasing the counterbore towards the spiral winding.

17. The method of claim 16, wherein the step of biasing the counterbore comprises coining the retaining ring.

18. The method of claim 16, further comprising the step of providing an additional retainer substantially between the counterbore and the spiral winding.
